(19) United States
(12) Patent Application Publication
(10) Pub. No.: US 2025/0231319 A1
(43) Pub. Date: Jul. 17, 2025

(54) ENHANCING HYDROCARBON PRODUCTION

(71) Applicant: Saudi Arabian Oil Company, Dhahran (SA)

(72) Inventors: Cenk Temizel, Dhahran (SA); Uchenna Odi, Houson, TX (US); Yousef Aliraani, Dhahran (SA); Karri Srinivasa Reddy, Dhahran (SA); Jana Alfaraj, Dhahran (SA)

(21) Appl. No.: 18/411,954

(22) Filed: Jan. 12, 2024

(51) Int. Cl. G01V 20/00; E21B 43/16

(52) U.S. Cl. CPC G01V 20/00; E21B 43/16; E21B 2200/20

(57) ABSTRACT

Disclosed are methods, systems, and computer-readable medium to perform operations including: obtaining input parameters describing a target wellbore for hydrocarbon production analysis; generating, based on the input parameters and a synthetic database of a plurality of simulated decline curve analysis (DCA)—estimated ultimate recovery (EUR) sets, a machine learning model for generating a target EUR for the target wellbore, where each of the plurality of simulated DCA-EUR sets includes: (i) a simulated DCA generated based on respective simulation data, and (ii) a corresponding EUR for the simulated DCA; generating, based on the input parameters, a target DCA for the target wellbore that forecasts the decline curve for the target wellbore; and providing the target DCA as input to the machine learning model, where the machine learning model outputs the target EUR for the target wellbore, and where the target DCA and the target EUR form a target DCA-EUR set.

### TECHNICAL FIELD

This disclosure relates generally to systems and methods for enhancing hydrocarbon production.

### BACKGROUND

Decline curve analysis (DCA) is a technique that involves examining a graphical representation of a production rate of a hydrocarbon well to predict the decline in the production rate of the well over time. The decline in production rate over time can be due to changing volumes of production fluids, a loss of reservoir pressure, and the like. Wells generally produce at a maximum production rate near the beginning of operational life, and due to declining production rates are eventually depleted or no longer profitable.

### SUMMARY

One aspect of the subject matter described in this specification may be embodied in a method that includes: obtaining input parameters describing a target wellbore for hydrocarbon production analysis; generating, based on the input parameters and a synthetic database of a plurality of simulated decline curve analysis (DCA)—estimated ultimate recovery (EUR) sets, a machine learning model for generating a target EUR for the target wellbore, where each of the plurality of simulated DCA-EUR sets includes: (i) a simulated DCA generated based on respective simulation data, and (ii) a corresponding EUR for the simulated DCA; generating, based on the input parameters, a target DCA for the target wellbore that forecasts the decline curve for the target wellbore; and providing the target DCA as input to the machine learning model, where the machine learning model outputs the target EUR for the target wellbore, and where the target DCA and the target EUR form a target DCA-EUR set.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the input parameters include a location of the target wellbore, a porosity of a reservoir in which the wellbore is drilled, a permeability of the reservoir, a frac conductivity of the reservoir, a number of hydraulic fracturing stages in a hydraulic fracturing operation in the reservoir, a fracture length, a fracture height, hydrocarbon saturation, cluster spacing between perforation clusters in the hydraulic fracturing operation, stage spacing, or reservoir pressure.

In some implementations, generating the machine learning model involves identifying a subset of the plurality of simulated DCA-EUR sets that corresponds to the input parameters; and using the subset of the plurality of simulated DCA-EUR sets as training data for the machine learning model. In some examples, identifying a subset of the plurality of simulated DCA-EUR sets that corresponds to the input parameters involves searching the database for simulated DCA-EUR sets that are associated with simulation parameters that have a threshold level of similarity with the input parameters. More specifically, the computer system can generate a comparison score by comparing the input parameters and the simulation parameters of the plurality of simulated DCA-EUR sets. Then, the computer system can select a subset of the simulated DCA-EUR sets whose simulation parameters have a comparison score that is greater than or equal to a predetermined threshold.

In some implementations, generating the synthetic database using the physics-based reservoir simulator involves: using an optimizer to select a plurality of simulation scenarios described by the respective simulation data; for each simulation scenario, using the respective simulation data and the physics-based reservoir simulator to generate a corresponding simulated DCA-EUR set; and storing the corresponding simulated DCA-EUR set in the synthetic database.

In some implementations, the method further involves: for each simulation scenario, calculating an EUR accuracy for the corresponding simulated DCA-EUR set; and storing the EUR accuracy in the synthetic database such that the EUR accuracy is associated with the corresponding simulated DCA-EUR set.

In some implementations, the method further involves calculating, using the machine learning model, an accuracy of the target EUR.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 illustrates an example workflow for enhancing production and expected ultimate recovery forecasting, according to some implementations.

FIG. 2 illustrates a flowchart of an example method, according to some implementations.

FIGS. 3A-6E illustrate an example modeling scenario, according to some implementations.

FIG. 7 illustrates hydrocarbon production operations that include both one or more field operations and one or more computational operations, according to some implementations.

FIG. 8 is a partial schematic perspective view of an example rig system for drilling and producing a well, according to some implementations.

FIG. 9 is a block diagram of an example computer system, according to some implementations.

### DETAILED DESCRIPTION

Decline curve analysis (DCA) is a forecasting technique based on an assumption that past trends can be distinguished and used to predict future well performance. The method involves plotting production rates against time and applying forecasting techniques (e.g., curve fitting to the plotted data) to predict how the production rate will decline over time as the reservoir is depleted. Expected ultimate recovery (EUR) is a related technique that estimates the total recoverable reserves from a resource, such as a reservoir in which the well is drilled. Both techniques have been applied to conventional natural gas reservoirs. As an example, Arps' empirical model uses both techniques for natural gas reservoir modeling. Arps' decline curves are applied by adjusting two fitting parameters with constraints associated with historical rates in conventional gas reservoirs under a boundary-dominated flow regime. More robust analysis models, such as Fetkovich type curves, were subsequently developed to provide more realistic production forecasts, flow regime identification (e.g., transient or boundary dominated) and estimation of the drainage area (A), permeability (k), and skin (s).

More recently, these legacy techniques have been adapted (e.g., using segmental analysis) to characterize more extreme production decline trends in a range of unconventional hydrocarbon reservoirs (e.g., tight reservoirs). The time, extent, and quality of the historical production data from a specific well, or the reservoir as a whole, substantially influences the accuracy that can be achieved by a particular DCA method and the confidence levels that can be assigned to the method's estimates.

Available information on wellbore conditions, subsurface geological, reservoir engineering details, and other operational variables, in addition to historical production volume versus time data, can help locate analogous reservoirs for which decline trends and EUR can be used as a guide to assess well flow rate forecasts and EUR estimates. Rate versus time and log-log dimensionless rate versus time graphical analysis of historical production trends provide a useful way to display and analyze DCA trends and/or present their extrapolations into future periods. The information and reservoir insight gained from comprehensive DCA can assist in gas field sustainability. For instance, applying suitable decline curve techniques enables reliable estimates of EUR to be readily derived for gas wells for which historical production data is available.

The radius of investigation (ROI) is generally defined as the distance that a significant pressure change has advanced into the reservoir, e.g., from the well, at any specified time. This parameter has important implications related to reserves estimation and the understanding of stimulated reservoir volumes. Conventionally, ROI is a function of both rock and fluid properties. The uncertainty associated with critical input parameters ultimately influences the production forecast used by Arps' model. Uncertainty increases when dealing with ultra-low permeability reservoirs with limited production data. Traditionally, ROI was developed assuming Darcy's flow, Newtonian fluid, and isotropic and homogeneous reservoirs. Input parameters such as porosity, permeability, total testing time, rock and fluid compressibility, and fluid viscosity impacted calculated ROI values.

Currently, there is uncertainty associated with forecasts, including the DCA forecasts, as existing methods face difficulty in forecasting well performance with limited initial data, which may generally range from 30 days to 360 days, especially for unconventional reservoirs (e.g., unconventional shale reservoirs). Although a longer duration of initial data provides a better forecast that fits the initial data, it is not practical to wait for longer periods to make a forecast as EUR is a critical parameter to accurately obtain at the earliest possible time. Additionally, existing methods do not provide an accurate assessment of uncertainty in the calculated EUR. Rather, the existing methods only provide a rough estimate of uncertainty based on an analysis that uses 4 assumptions related to uncertainty in key parameters. This probabilistic approach provides uncertainty ranges that are at best a rough approximation.

This disclosure describes systems and methods for a hybrid forecasting approach. The hybrid forecasting approach is implemented by a hybrid forecasting system that uses a physics-based reservoir simulator (i.e., a physics-based modelling approach) and machine learning algorithms (i.e., data driven techniques). In one embodiment, the hybrid forecasting system uses the physics-based reservoir simulator to generate a universal database of DCAs and associated EURs as a set. The sets are mapped to different reservoir characteristics. The hybrid forecasting system then uses the universal database to build a machine learning forecasting model, which can be tailored for a specific scenario or target case (e.g., a reservoir or wellbore of interest). In particular, the hybrid forecasting system trains the machine learning model using reservoir and completion data (e.g., describing the reservoir of interest) in addition to the DCA-EUR sets from the universal database. The hybrid forecasting system can perform a DCA for the target case based on the target case's initial production data. Then, the hybrid forecasting system can use the machine learning model to generate a EUR for the DCA graph. Additionally, the hybrid forecasting system can estimate an uncertainty of the EUR forecast. The hybrid forecasting system can do so by virtue of already knowing the actual production that is obtained with the physics-based reservoir simulation for similar DCAs associated with similar initial production data and similar reservoir/wellbore characteristics. In this way, the hybrid forecasting system can determine expected well performance (e.g., a EUR forecast) and an accurate uncertainty associated with the expected well performance, even with limited initial production data.

The universal database includes parameters in wide-enough ranges and estimator points for forecasting EUR and evaluating the accuracy of EUR predictions using decline curve and machine learning methods. The accuracy tied to the predictions is based on (i) initial production data at different extents and durations, and (ii) the key reservoir parameters governing the time the well goes through different flow regimes in the reservoirs (e.g., unconventional shale reservoirs). Such evaluation/calculation not only yields the EUR, but also the accuracy which is important in production forecasting. In particular, the evaluation/calculation provides a means to manage initial productions and flow periods for the required extent/duration of flow. The hybrid forecasting system enables the prediction of EURs and/or the associated uncertainty for a wide range of wells with different degrees of maturity serving as a tool/method to obtain these parameters at an early stage of the lifecycle of the fields.

As such, unlike existing systems, the hybrid forecasting system can accurately forecast production in unconventional reservoirs (e.g., unconventional shale reservoirs, ultra-low permeability reservoirs, etc.) with limited production data. Additionally, the hybrid forecasting system can improve resource recovery through the optimization of the number of wells drilled and the spacing to efficiently achieve an enhanced EUR. The hybrid forecasting system can provide instructions to drilling systems, e.g., to control such drilling systems, to drill the specified number of wells at the determined spacing, thereby achieving an enhanced hydrocarbon production.

The physics-based models—used in the physics-based simulator—represent the governing laws of nature and innately embed the concepts of time, space, causality, and generalizability. These laws of nature define how physical, chemical, biological, and geological processes evolve in the physical world. The physics-based models integrate data, partial differential equations (PDEs), and mathematical models to solve data shift problems. Further, the physics-based models are trained to solve supervised learning tasks while adhering to laws of physics described by general nonlinear equations. Binary classification, multiclass classification, and regression are some methods that can be selected depending on the type of target to be predicted. The physics-based models enable understanding of complex processes and predicting future events based on information about the target case.

Generally, data-driven approaches use information from previously collected data (e.g., training data) to identify the measured pressure, temperature, or production rate characteristics and predict future trends. Physics-based approaches, on the other hand, assume that a physical model describing the behavior behind these measurements is available, sufficiently accurate, and self-contained to predict future behavior. A hybrid approach combines both approaches by combining data with material assumptions to connect what is observed with what can be predicted and controlled in the reservoir.

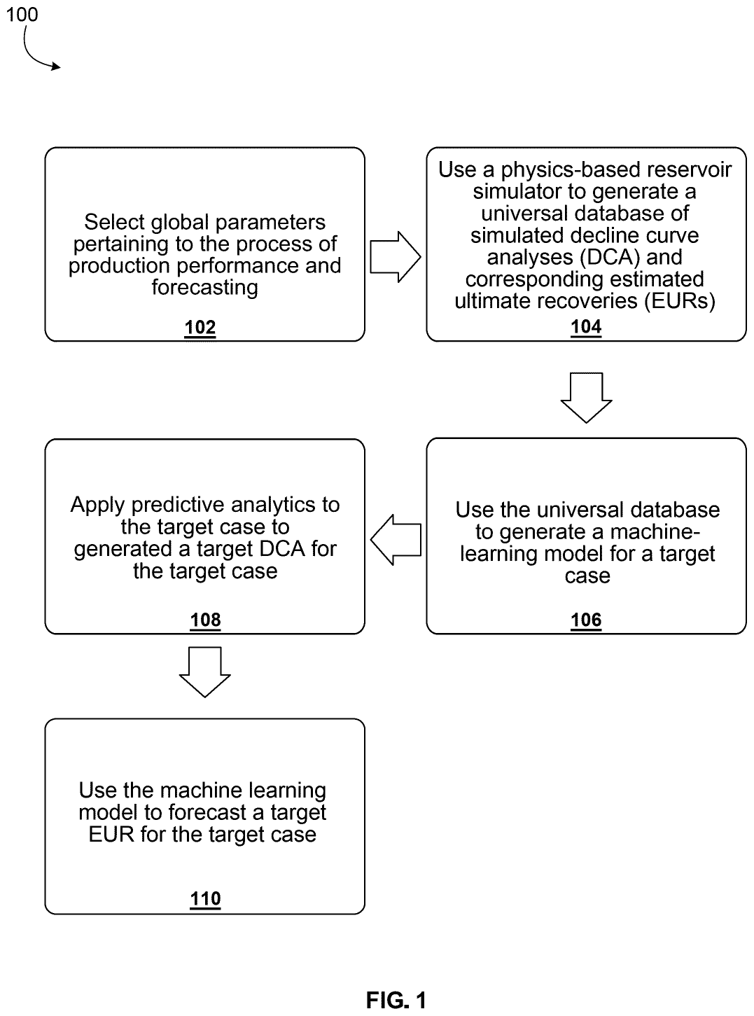

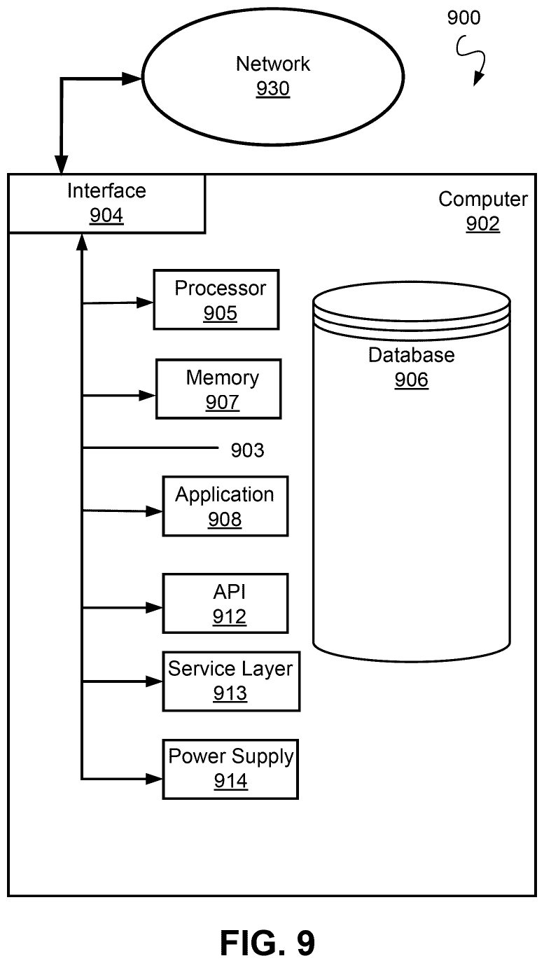

FIG. 1 illustrates an example workflow 100 for enhancing production and expected ultimate recovery forecasting, according to some implementations. For convenience, the workflow 100 will be described as being performed by a computer system (also called a hybrid forecasting system) having one or more computers located in one or more locations and programmed appropriately in accordance with this specification. An example of the computer system is the computing system 900 illustrated in FIG. 9 described below.

At 102, the computer system selects global parameters pertaining to the process of production performance and forecasting. Generally, the global parameters include reservoir, completion, and stimulation parameters that can be adjusted per the requirements of the target case depending on the target case's specifications. Completion parameters include data that describes how a well is completed. Such data includes (i) tubing and casing information, (ii) perforation data, (iii) data describing production tubing and downhole equipment, and/or (iv) well completion designs. In some examples, the global parameters include, but are not limited to, porosity, permeability, frac conductivity, number of stages, fracture length, fracture height, hydrocarbon saturation, cluster spacing, stage spacing, and reservoir pressure.

At 104, the computer system uses a physics-based reservoir simulator to generate a universal database of simulated DCAs and associated EURs. More specifically, the computer system uses the full-physics reservoir simulator and the selected global parameters to simulate one or more wells in one or more reservoirs. Then, the computer system generates respective DCAs and associated EURs for each of the one or more wells. To generate the DCAs and the associated EURs for a well, the computer system simulates performance of the well up to a certain period, e.g., 30 days. Then, the computer system uses the simulated production data for that time period to perform a decline curve analysis for a longer period (e.g., on the order of years). The computer system also calculates an estimated ultimate recovery based on the initial simulated production data. The computer system then associates the DCA with the calculated EUR and stores the association as a DCA-EUR datapoint in the universal database. Additionally, the computer system includes the global parameters that were used to generate DCA-EUR datapoint as metadata associated with the DCA-EUR datapoint. Thus, parameters of the well associated with the DCA-EUR datapoint can be identified. In some examples, the computer system can repeat the simulation for different periods, e.g., 30 days, 60 days, and so on.

In some implementations, the computer system can also determine an accuracy of the generated data. For example, after simulating the performance of the well up to a specified period (e.g., 30 days) and calculating the DCA-EUR dataset for the well, the computer system can continue simulating performance of the well until a predetermined stopping point (e.g., the well's resources are depleted or until the well is no longer profitable). Then, the computer system can compare the simulated ultimate recovery to the expected ultimate recovery to calculate the accuracy of the prediction. The computer system can map the calculated prediction and accuracy to the corresponding DCA-EUR dataset.

In some implementations, the physics-based simulator includes physics-based fracture propagation models that can simulate the propagation/growth of fractures. Additionally, the physics-based simulator includes physics-based reservoir production models that can model hydrocarbon production from the stimulated and/or hydraulically fractured reservoir rock. Thus, for a set of input parameters (corresponding to a single scenario), the physics-based simulator can calculate the resulting fracture geometry as well as the associated production from the reservoir. The set of input parameters and the corresponding output are the input and output, respectively, of a single iteration. The process is then repeated (e.g., on the order of tens or hundreds of thousands of times) to capture different input parameter combinations using an optimizer that controls each simulation for the given parameters and ranges (e.g., time ranges) to generate the universal database.

At 106, the computer system uses data from the universal database to generate a machine learning model for a target case. To do so, the computer system evaluates the target case to determine parameters that characterize the target case. The parameters include, but are not limited to, a location of the target wellbore, a porosity of a reservoir in which the wellbore is drilled, a permeability of the reservoir, a frac conductivity of the reservoir, a number of hydraulic fracturing stages in a hydraulic fracturing operation in the reservoir, a fracture length, a fracture height, hydrocarbon saturation, cluster spacing between perforation clusters in the hydraulic fracturing operation, stage spacing, or reservoir pressure. Then, the computer system uses the parameters and data from the universal database to train a machine learning model tailored to the target case. As explained below, the machine learning model can be used to forecast EUR and can additionally calculate the accuracy/uncertainty of the forecasted data.

In some implementations, the generated database is utilized by a ML algorithm to establish the relationship between the inputs and the outputs. Then, the ML model is generated by fitting the relationship, e.g., adjusting the model's parameters so that it can accurately predict the output (or target) from the input data. In some examples, the significance of the parameters plays role in the selection of the parameters as the least significant ones can be neglected. Within examples, the machine learning algorithms includes Artificial Neural Networks, Genetic Algorithms, random forests, support vectors machines, generative adversarial networks, among other examples.

At 108, the computer system applies predictive analytics to the target case. In this step, the hybrid obtains initial production data, e.g., gas rate in million standard cubic feet per day (MSCFD), for the target case. The initial production data can include the gas rate for a specified period, e.g., 30 days, 60 days, 180 days, or 360 days. The computer system then applies a predictive analysis to the initial production data. For instance, the computer system applies DCA to the initial production data. Applying DCA can involve determining a decline curve, e.g., exponential decline, harmonic decline, or hyperbolic decline, that can be used to fit the data points of the initial production data. Examples of applying predictive analytics to initial production data are shown below.

At 110, the computer system uses the machine learning model to forecast a target EUR based on the DCA of the target case. To do so, the machine learning model can use its training to identify a EUR that corresponds to the DCA. Additionally, the computer system can use the machine learning model to estimate the accuracy of the DCA-EUR for the target case. To do so, the computer system provides to the machine learning model input data that includes initial production for the target case and reservoir/completion characteristics. The reservoir/completion characteristics include, but are not limited to, porosity, permeability, frac conductivity, number of stages, fracture length, fracture height, hydrocarbon saturation, cluster spacing, stage spacing, reservoir pressure. The machine learning model uses its training to identify a DCA-EUR set similar to the DCA-EUR set for the target case. The machine learning model identifies an accuracy of the DCA-EUR set and uses that accuracy as the accuracy/uncertainty for the DCA-EUR set for the target case.

In some implementations, the significance of the input parameters on the output (e.g., EUR) is identified, which enables optimum values for the selected parameters to be applied in future wells. Doing so reduces the uncertainty in planning the future wells and optimizes field development.

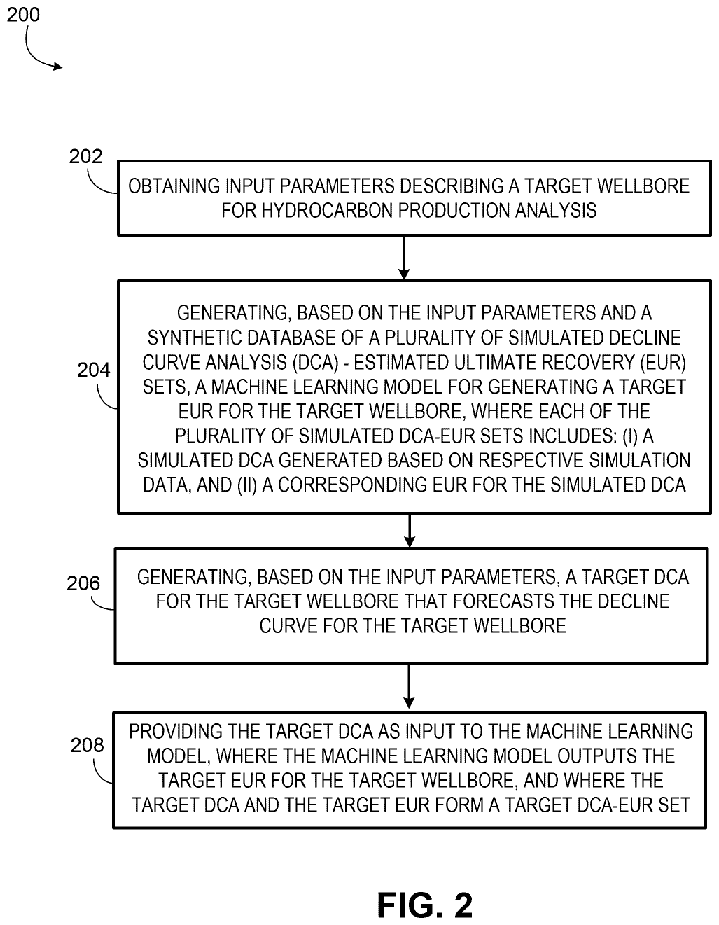

FIG. 2 illustrates a flowchart of an example method 200, according to some implementations. For clarity of presentation, the description that follows generally describes method 200 in the context of the other figures in this description. For example, method 200 can be performed by computer system 900 of FIG. 2. It will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

At 202, method 200 involves obtaining input parameters describing a target wellbore for hydrocarbon production analysis.

At 204, method 204 involves generating, based on the input parameters and a synthetic database of a plurality of simulated decline curve analysis (DCA)—estimated ultimate recovery (EUR) sets, a machine learning model for generating a target EUR for the target wellbore, where each of the plurality of simulated DCA-EUR sets includes: (i) a simulated DCA generated based on respective simulation data, and (ii) a corresponding EUR for the simulated DCA.

At 206, method 200 involves generating, based on the input parameters, a target DCA for the target wellbore that forecasts the decline curve for the target wellbore. This involves plotting production rates against time and applying forecasting techniques (e.g., curve fitting to the plotted data) to predict how the production rate will decline over time as the reservoir is depleted.

At 208, method 200 involves providing the target DCA as input to the machine learning model, where the machine learning model outputs the target EUR for the target wellbore, and where the target DCA and the target EUR form a target DCA-EUR set.

In some implementations, the input parameters include a location of the target wellbore, a porosity of a reservoir in which the wellbore is drilled, a permeability of the reservoir, a frac conductivity of the reservoir, a number of hydraulic fracturing stages in a hydraulic fracturing operation in the reservoir, a fracture length, a fracture height, hydrocarbon saturation, cluster spacing between perforation clusters in the hydraulic fracturing operation, stage spacing, or reservoir pressure.

In some implementations, generating the machine learning model involves identifying a subset of the plurality of simulated DCA-EUR sets that corresponds to the input parameters; and using the subset of the plurality of simulated DCA-EUR sets as training data for the machine learning model. In some examples, identifying a subset of the plurality of simulated DCA-EUR sets that corresponds to the input parameters involves searching the database for simulated DCA-EUR sets that are associated with simulation parameters that have a threshold level of similarity with the input parameters. More specifically, the computer system can generate a comparison score by comparing the input parameters and the simulation parameters of the plurality of simulated DCA-EUR sets. Then, the computer system can select a subset of the simulated DCA-EUR sets whose simulation parameters have a comparison score that is greater than or equal to a predetermined threshold.

In some implementations, generating the synthetic database using the physics-based reservoir simulator involves: using an optimizer to select a plurality of simulation scenarios described by the respective simulation data; for each simulation scenario, using the respective simulation data and the physics-based reservoir simulator to generate a corresponding simulated DCA-EUR set; and storing the corresponding simulated DCA-EUR set in the synthetic database.

In some implementations, the method further involves: for each simulation scenario, calculating an EUR accuracy for the corresponding simulated DCA-EUR set; and storing the EUR accuracy in the synthetic database such that the EUR accuracy is associated with the corresponding simulated DCA-EUR set.

In some implementations, the method further involves calculating, using the machine learning model, an accuracy of the target EUR.

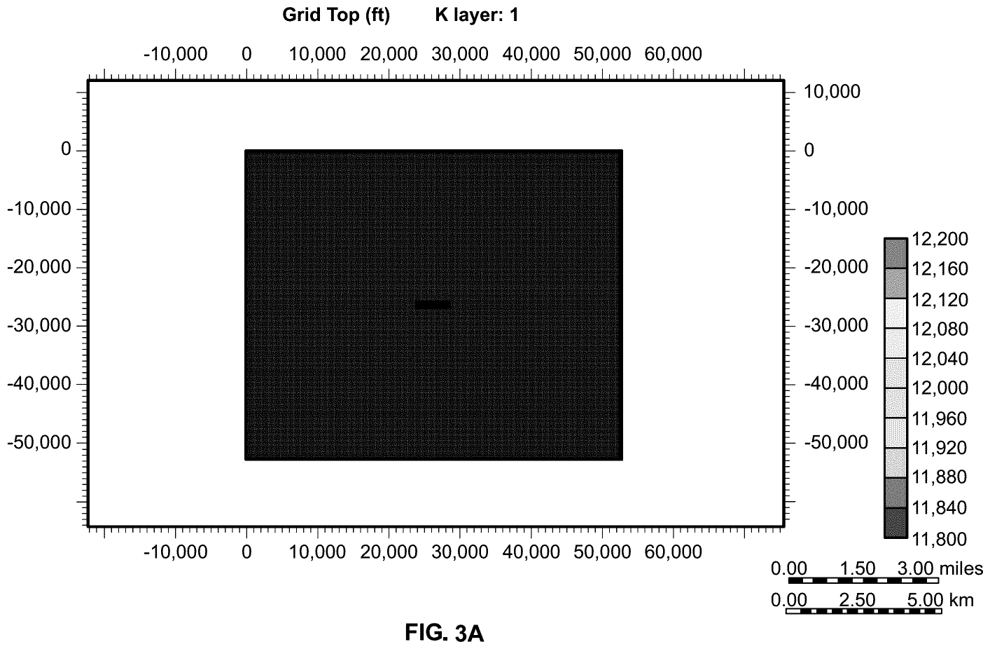

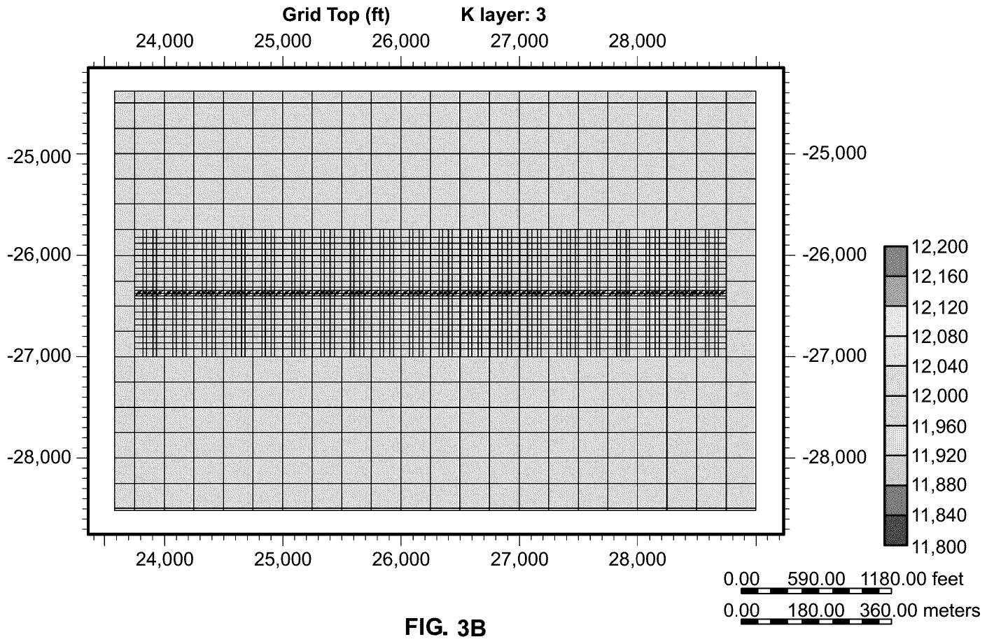

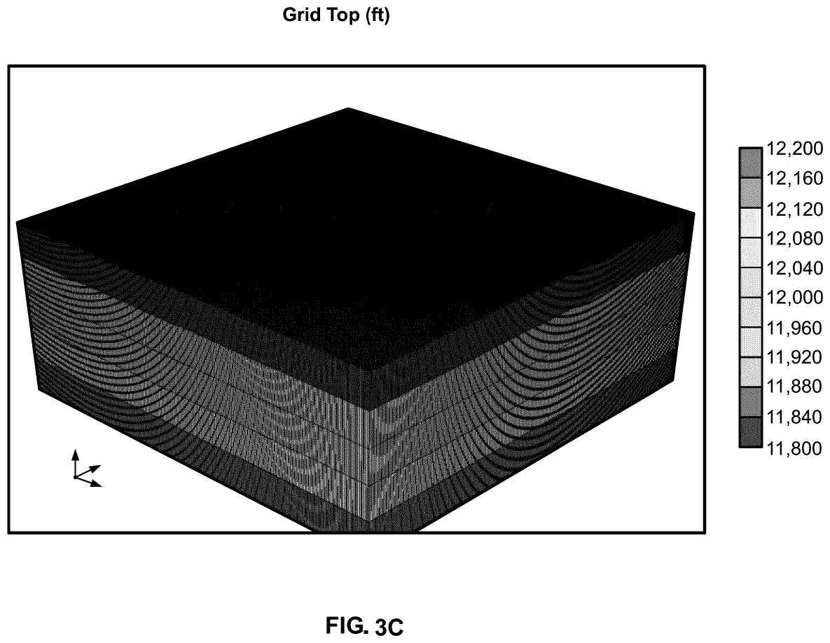

FIGS. 3A-6E illustrate an example modeling scenario, according to some implementations. In this scenario, a synthetic model is generated resembling a shale play. Additionally, in this scenario permeability (as one of the impactful factors) has been varied from 1× to 100×, where 1× corresponds to a permeability of 10 nanodarcy (nd), 5× to 50 nd, 10× to 100 nd, 25× to 250 nd, and 100× to 1000 nd. In this modeling, “Well 1” refers to the 1× permeability case, “Well 5” refers to the 5× permeability case, “Well 10” refers to the 10× permeability case, “Well 25” refers to the 25× permeability case, and “Well 100” refers to the 100× permeability case.

FIG. 3A, FIG. 3B, and FIG. 3C illustrate a model used for the illustrative data generation in the modeling scenario. Specifically, FIG. 3A illustrates a grid top of the single well model in two-dimensions (2D). FIG. 3B illustrates a well perforation model of the well and FIG. 3C illustrates a three-dimensional (3D) view of the single well model.

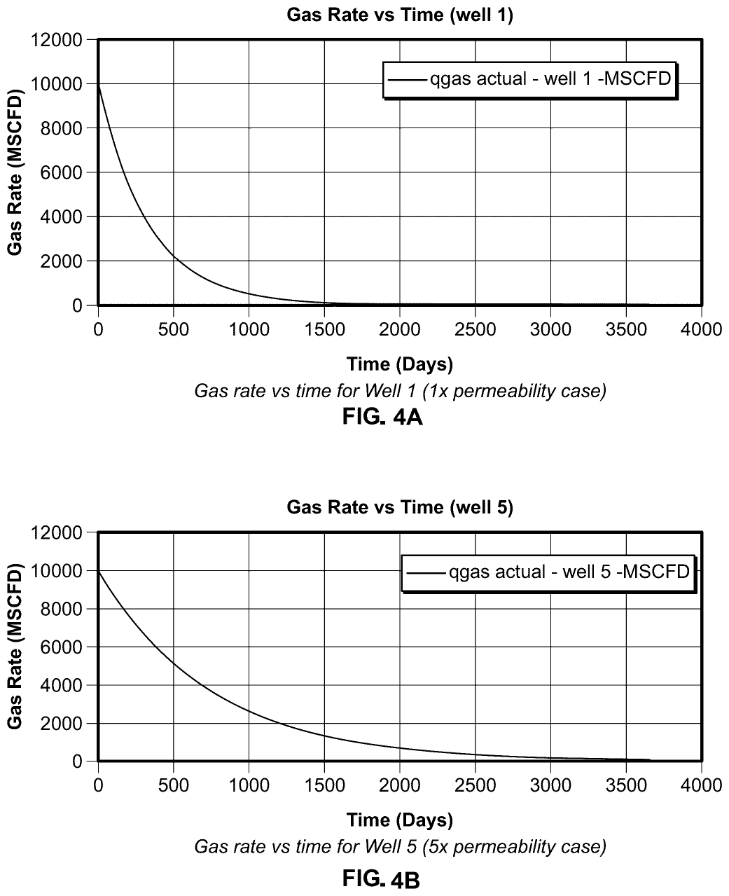

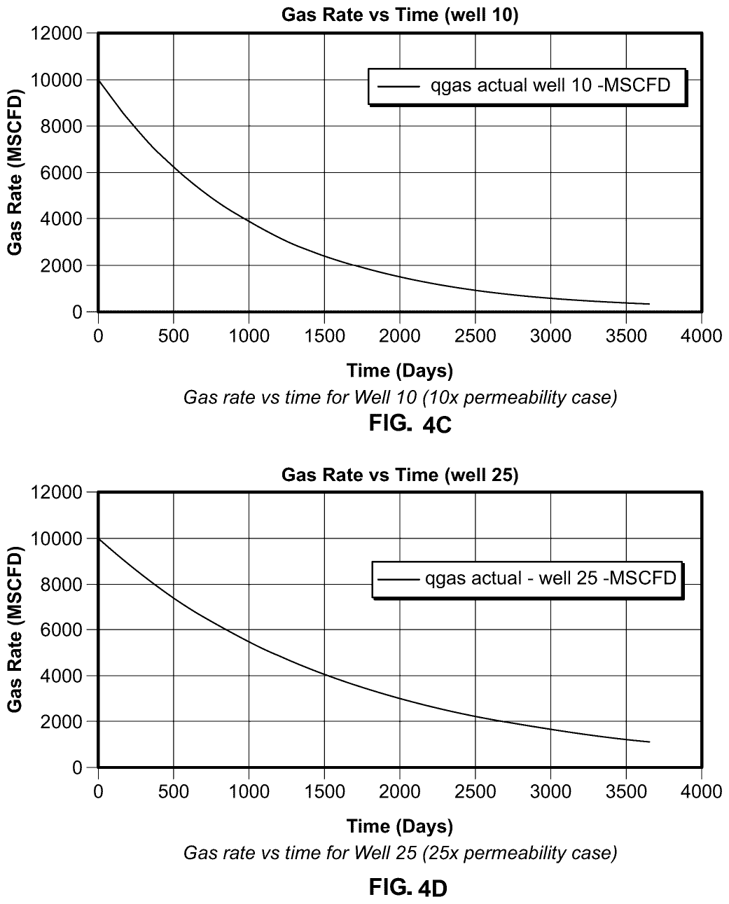

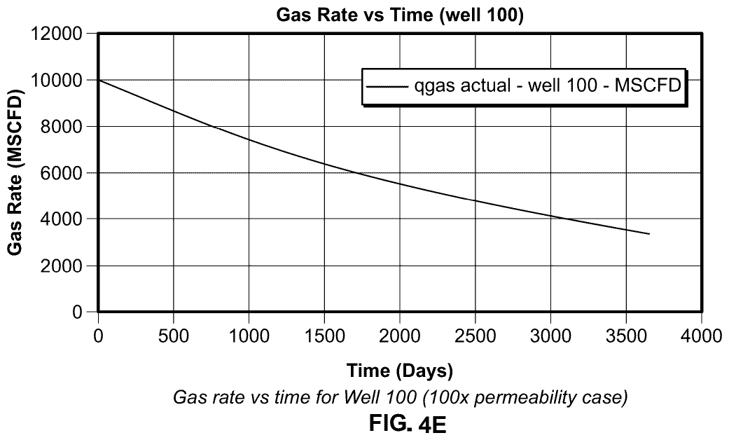

FIGS. 4A-4E illustrate the actual (simulated) gas rates for Wells 1-5. Based on the result of sensitivities of permeabilities that are shown in these figures, it can be concluded that Stimulated Reservoir Volume (SRV) permeability alterations impact the production directly. As shown in these figures, the higher the SRV permeability, the higher the productivity of the well.

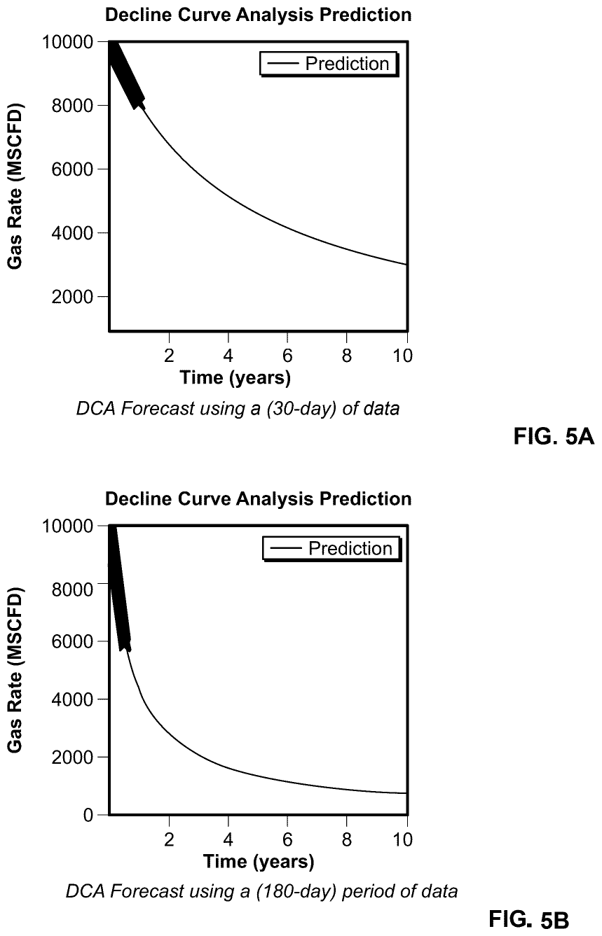

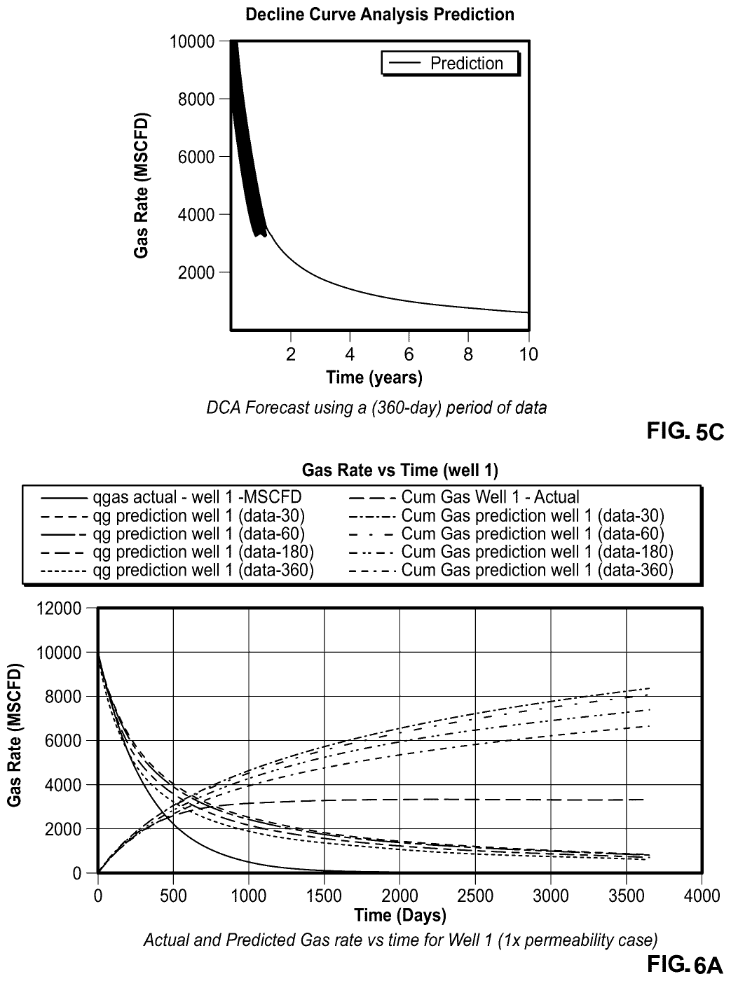

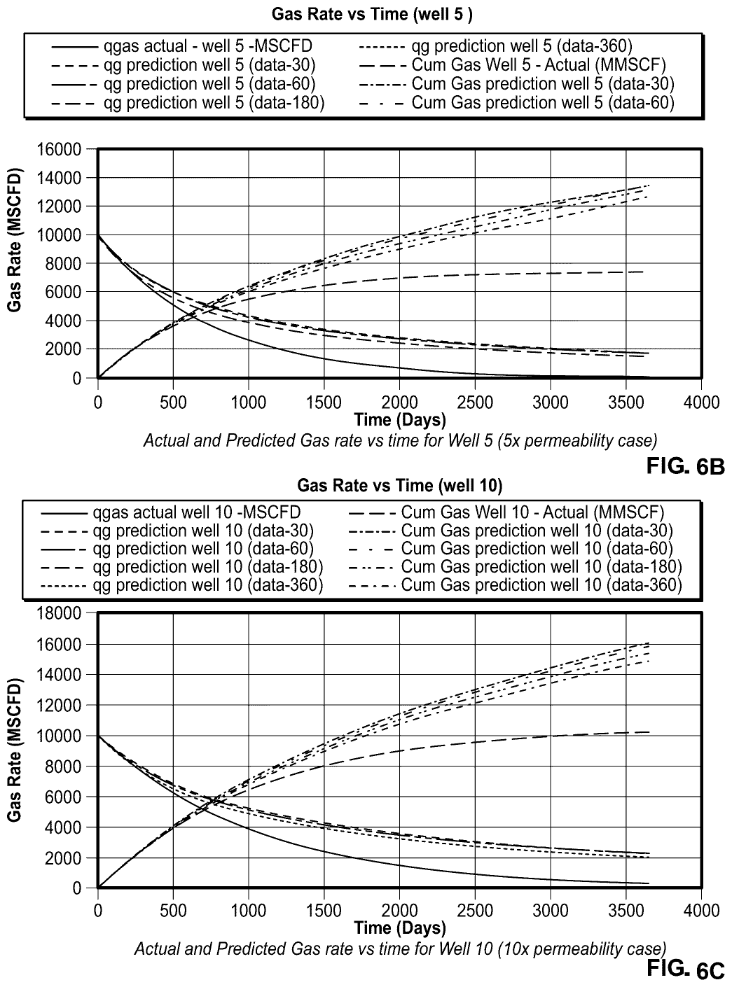

FIGS. 5A-5C illustrate DCA forecasting performed using a 30 day period, a 180 day period, and a 360 day period. And FIGS. 6A-6E illustrate the actual vs predicted gas rates for Wells 1-5.

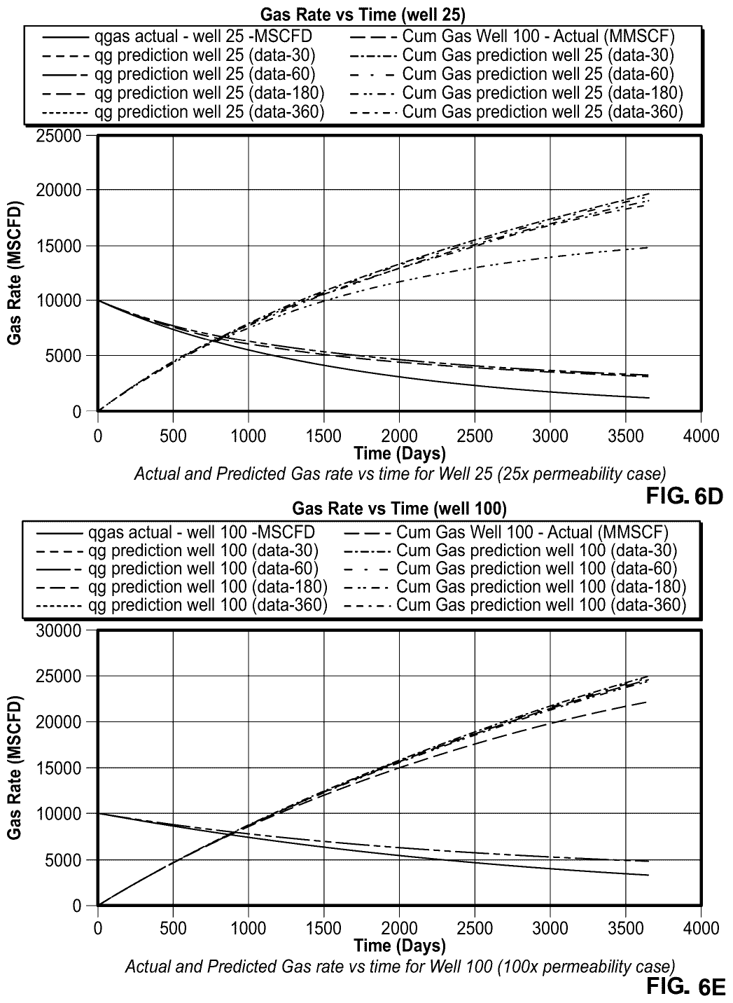

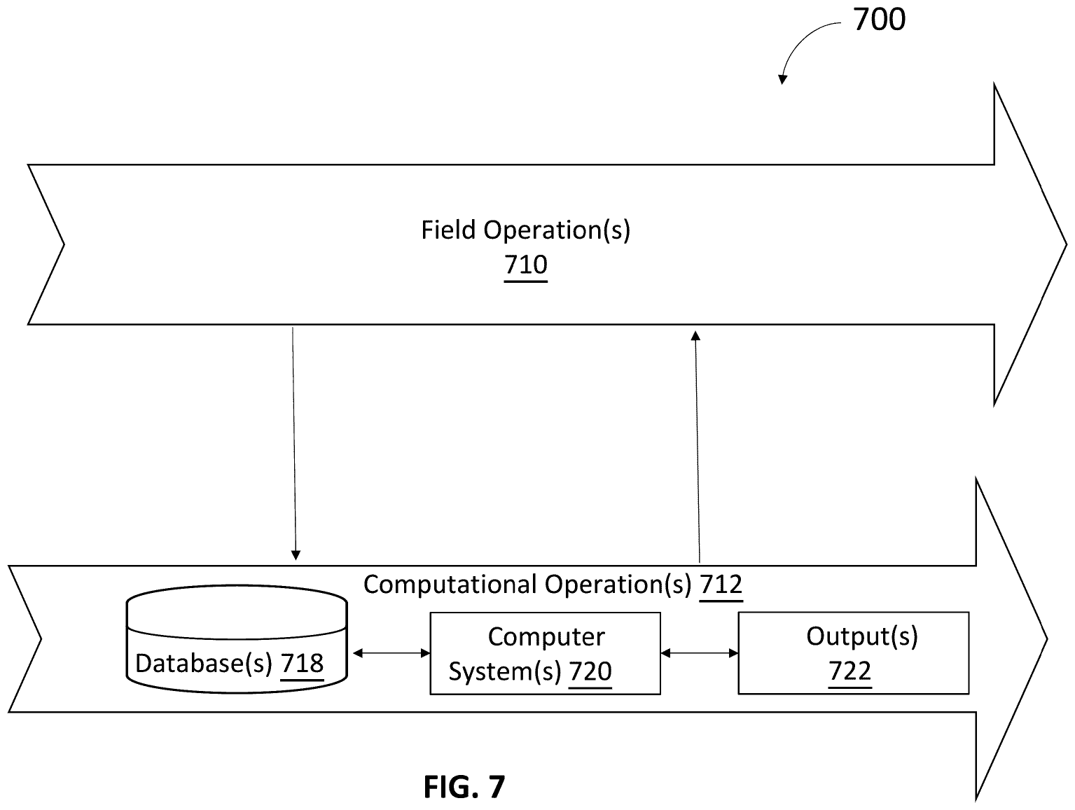

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

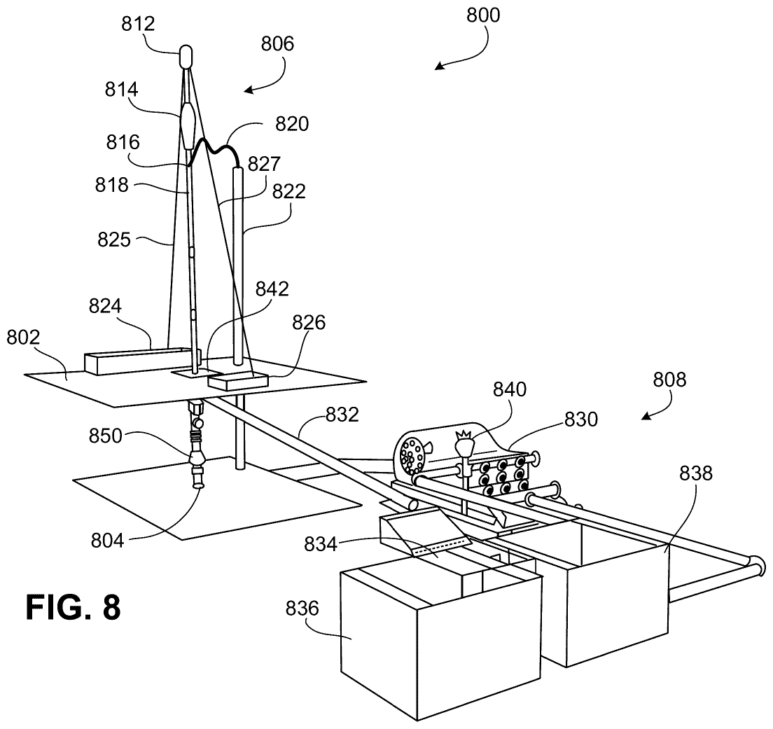

FIG. 8 is a partial schematic perspective view of an example rig system 800 for drilling and producing a well. The well can extend from the surface through the Earth to one or more subterranean zones of interest. The example rig system 800 includes a drill floor 802 positioned above the surface, a wellhead 804, a drill string assembly 806 supported by the rig structure, a fluid circulation system 808 to filter used drilling fluid from the wellbore and provide clean drilling fluid to the drill string assembly 806. For example, the example rig system 800 of FIG. 8 is shown as a drill rig capable of performing a drilling operation with the rig system 800 supporting the drill string assembly 806 over a wellbore. The wellhead 804 can be used to support casing or other well components or equipment into the wellbore of the well.

The derrick or mast is a support framework mounted on the drill floor 802 and positioned over the wellbore to support the components of the drill string assembly 806 during drilling operations. A crown block 812 forms a longitudinally-fixed top of the derrick, and connects to a travelling block 814 with a drilling line including a set of wire ropes or cables. The crown block 812 and the travelling block 814 support the drill string assembly 806 via a swivel 816, a kelly 818, or a top drive system (not shown). Longitudinal movement of the travelling block 814 relative to the crown block 812 of the drill string assembly 806 acts to move the drill string assembly 806 longitudinally upward and downward. The swivel 816, connected to and hung by the travelling block 814 and a rotary hook, allows free rotation of the drill string assembly 806 and provides a connection to a kelly hose 820, which is a hose that flows drilling fluid from a drilling fluid supply of the circulation system 808 to the drill string assembly 806. A standpipe 822 mounted on the drill floor 802 guides at least a portion of the kelly hose 820 to a location proximate to the drill string assembly 806. The kelly 818 is a hexagonal device suspended from the swivel 816 and connected to a longitudinal top of the drill string assembly 806, and the kelly 818 turns with the drill string assembly 806 as the rotary table 842 of the drill string assembly turns.

In the example rig system 800 of FIG. 8, the drill string assembly 806 is made up of drill pipes with a drill bit (not shown) at a longitudinally bottom end of the drill string. The drill pipe can include hollow steel piping, and the drill bit can include cutting tools, such as blades, discs, rollers, cutters, or a combination of these, to cut into the formation and form the wellbore. The drill bit rotates and penetrates through rock formations below the surface under the combined effect of axial load and rotation of the drill string assembly 806. In some implementations, the kelly 818 and swivel 816 can be replaced by a top drive that allows the drill string assembly 806 to spin and drill. The wellhead assembly 804 can also include a drawworks 824 and a deadline anchor 826, where the drawworks 824 includes a winch that acts as a hoisting system to reel the drilling line in and out to raise and lower the drill string assembly 806 by a fast line 825. The deadline anchor 826 fixes the drilling line opposite the drawworks 824 by a deadline 827, and can measure the suspended load (or hook load) on the rotary hook. The weight on bit (WOB) can be measured when the drill bit is at the bottom the wellbore. The wellhead assembly 804 also includes a blowout preventer 850 positioned at the surface of the well and below (but often connected to) the drill floor 802. The blowout preventer 850 acts to prevent well blowouts caused by formation fluid entering the wellbore, displacing drilling fluid, and flowing to the surface at a pressure greater than atmospheric pressure. The blowout preventer 850 can close around (and in some instances, through) the drill string assembly 806 and seal off the space between the drill string and the wellbore wall.

During a drilling operation of the well, the circulation system 808 circulates drilling fluid from the wellbore to the drill string assembly 806, filters used drilling fluid from the wellbore, and provides clean drilling fluid to the drill string assembly 806. The example circulation system 808 includes a fluid pump 830 that fluidly connects to and provides drilling fluid to drill string assembly 806 via the kelly hose 820 and the standpipe 822. The circulation system 808 also includes a flow-out line 832, a shale shaker 834, a settling pit 836, and a suction pit 838. In a drilling operation, the circulation system 808 pumps drilling fluid from the surface, through the drill string assembly 806, out the drill bit and back up the annulus of the wellbore, where the annulus is the space between the drill pipe and the formation or casing. The density of the drilling fluid is intended to be greater than the formation pressures to prevent formation fluids from entering the annulus and flowing to the surface and less than the mechanical strength of the formation, as a greater density may fracture the formation, thereby creating a path for the drilling fluids to go into the formation. Apart from well control, drilling fluids can also cool the drill bit and lift rock cuttings from the drilled formation up the annulus and to the surface to be filtered out and treated before it is pumped down the drill string assembly 806 again. The drilling fluid returns in the annulus with rock cuttings and flows out to the flow-out line 832, which connects to and provides the fluid to the shale shaker 834. The flow line is an inclined pipe that directs the drilling fluid from the annulus to the shale shaker 834. The shale shaker 834 includes a mesh-like surface to separate the coarse rock cuttings from the drilling fluid, and finer rock cuttings and drilling fluid then go through the settling pit 836 to the suction pit 836. The circulation system 808 includes a mud hopper 840 into which materials (for example, to provide dispersion, rapid hydration, and uniform mixing) can be introduced to the circulation system 808. The fluid pump 830 cycles the drilling fluid up the standpipe 822 through the swivel 816 and back into the drill string assembly 806 to go back into the well.

The example wellhead assembly 804 can take a variety of forms and include a number of different components. For example, the wellhead assembly 804 can include additional or different components than the example shown in FIG. 8. Similarly, the circulation system 808 can include additional or different components than the example shown in FIG. 8.

FIG. 9 is a block diagram of an example computer system 900 that can be used to provide computational functionalities associated with described algorithms, methods, functions, processes, flows, and procedures, according to some implementations of the present disclosure.

The illustrated computer 902 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 902 can include a Smart Embedded Management Agent (SEMA), such as a built-in ADLINK SEMA 2.2, and a video sync technology, such as Quick Sync Video technology supported by ADLINK MSDK+. In some examples, the computer 902 can include the MXE-5400 Series processor-based fanless embedded computer by ADLINK, though the computer 902 can take other forms or include other components.

The computer 902 can serve in a role as a client, a network component, a server, a database, a persistency, or components of a computer system for performing the subject matter described in the present disclosure. The illustrated computer 902 is communicably coupled with a network 930. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 930 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 903. In some implementations, any or all of the components of the computer 902, including hardware or software components, can interface with each other or the interface 904 (or a combination of both), over the system bus. Interfaces can use an application programming interface (API) 912, a service layer 913, or a combination of the API 912 and service layer 913. The API 912 can include specifications for routines, data structures, and object classes. The API 912 can be either computer-language independent or dependent. The API 912 can refer to a complete interface, a single function, or a set of APIs 912.

The service layer 913 can provide software services to the computer 902 and other components (whether illustrated or not) that are communicably coupled to the computer 902. The functionality of the computer 902 can be accessible for all service consumers using this service layer 913. Software services, such as those provided by the service layer 913, can provide reusable, defined functionalities through a defined interface. For example, the interface can be software written in JAVA, C++, or a language providing data in extensible markup language (XML) format. While illustrated as an integrated component of the computer 902, in alternative implementations, the API 912 or the service layer 913 can be stand-alone components in relation to other components of the computer 902 and other components communicably coupled to the computer 902. Moreover, any or all parts of the API 912 or the service layer 913 can be implemented as child or sub-modules of another software module, enterprise application, or hardware module without departing from the scope of the present disclosure.

The computer 902 can include an interface 904. Although illustrated as a single interface 904 in FIG. 9, two or more interfaces 904 can be used according to particular needs, desires, or particular implementations of the computer 902 and the described functionality. The interface 904 can be used by the computer 902 for communicating with other systems that are connected to the network 930 (whether illustrated or not) in a distributed environment. Generally, the interface 904 can include, or be implemented using, logic encoded in software or hardware (or a combination of software and hardware) operable to communicate with the network 930. More specifically, the interface 904 can include software supporting one or more communication protocols associated with communications. As such, the network 930 or the interface's hardware can be operable to communicate physical signals within and outside of the illustrated computer 902.

The computer 902 includes a processor 905. Although illustrated as a single processor 905 in FIG. 9, two or more processors 905 can be used according to particular needs, desires, or particular implementations of the computer 902 and the described functionality. Generally, the processor 905 can execute instructions and manipulate data to perform the operations of the computer 902, including operations using algorithms, methods, functions, processes, flows, and procedures as described in the present disclosure.

The computer 902 can also include a database 906 that can hold data for the computer 902 and other components connected to the network 930 (whether illustrated or not). For example, database 906 can be an in-memory, conventional, or a database storing data consistent with the present disclosure. In some implementations, the database 906 can be a combination of two or more different database types (for example, hybrid in-memory and conventional databases) according to particular needs, desires, or particular implementations of the computer 902 and the described functionality. Although illustrated as a single database 906 in FIG. 9, two or more databases (of the same, different, or combination of types) can be used according to particular needs, desires, or particular implementations of the computer 902 and the described functionality. While database 906 is illustrated as an internal component of the computer 902, in alternative implementations, database 906 can be external to the computer 902.

The computer 902 also includes a memory 907 that can hold data for the computer 902 or a combination of components connected to the network 930 (whether illustrated or not). Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 (of the same, different, or combination of types) can be used according to particular needs, desires, or particular implementations of the computer 902 and the described functionality. While memory 907 is illustrated as an internal component of the computer 902, in alternative implementations, memory 907 can be external to the computer 902.

An application 908 can be an algorithmic software engine providing functionality according to particular needs, desires, or particular implementations of the computer 902 and the described functionality. For example, an application 908 can serve as one or more components, modules, or applications 908. Multiple applications 908 can be implemented on the computer 902. Each application 908 can be internal or external to the computer 902.

The computer 902 can also include a power supply 914. The power supply 914 can include a rechargeable or non-rechargeable battery that can be configured to be either user- or non-user-replaceable. In some implementations, the power supply 914 can include power-conversion and management circuits, including recharging, standby, and power management functionalities. In some implementations, the power-supply 914 can include a power plug to allow the computer 902 to be plugged into a wall socket or a power source to, for example, power the computer 902 or recharge a rechargeable battery.

There can be any number of computers 902 associated with, or external to, a computer system including computer 902, with each computer 902 communicating over network 930. Further, the terms “client,” “user,” and other appropriate terminology can be used interchangeably without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
obtaining input parameters describing a target wellbore for hydrocarbon production analysis;
generating, based on the input parameters and a synthetic database of a plurality of simulated decline curve analysis (DCA)—estimated ultimate recovery (EUR) sets, a machine learning model for generating a target EUR for the target wellbore, wherein each of the plurality of simulated DCA-EUR sets comprises: (i) a simulated DCA generated based on respective simulation data, and (ii) a corresponding EUR for the simulated DCA;
generating, based on the input parameters, a target DCA for the target wellbore that forecasts the decline curve for the target wellbore; and
providing the target DCA as input to the machine learning model, wherein the machine learning model outputs the target EUR for the target wellbore, and wherein the target DCA and the target EUR form a target DCA-EUR set.

2. The computer-implemented method of claim 1, wherein the input parameters comprises a location of the target wellbore, a porosity of a reservoir in which the wellbore is drilled, a permeability of the reservoir, a frac conductivity of the reservoir, a number of hydraulic fracturing stages in a hydraulic fracturing operation in the reservoir, a fracture length, a fracture height, hydrocarbon saturation, cluster spacing between perforation clusters in the hydraulic fracturing operation, stage spacing, or reservoir pressure.

3. The computer-implemented method of claim 1, wherein generating the machine learning model comprises:
identifying a subset of the plurality of simulated DCA-EUR sets that corresponds to the input parameters; and
using the subset of the plurality of simulated DCA-EUR sets as training data for the machine learning model.

4. The computer-implemented method of claim 1, further comprising generating the synthetic database using a physics-based reservoir simulator.

5. The computer-implemented method of claim 4, wherein generating the synthetic database using the physics-based reservoir simulator comprises:
using an optimizer to select a plurality of simulation scenarios described by the respective simulation data;
for each simulation scenario, using the respective simulation data and the physics-based reservoir simulator to generate a corresponding simulated DCA-EUR set; and
storing the corresponding simulated DCA-EUR set in the synthetic database.

6. The computer-implemented method of claim 5, further comprising:
for each simulation scenario, calculating an EUR accuracy for the corresponding simulated DCA-EUR set; and
storing the EUR accuracy in the synthetic database such that the EUR accuracy is associated with the corresponding simulated DCA-EUR set.

7. The computer-implemented method of claim 1, further comprising calculating, using the machine learning model, an accuracy of the target EUR.

8. A system comprising:
one or more processors configured to perform operations comprising:
obtaining input parameters describing a target wellbore for hydrocarbon production analysis;
generating, based on the input parameters and a synthetic database of a plurality of simulated decline curve analysis (DCA)—estimated ultimate recovery (EUR) sets, a machine learning model for generating a target EUR for the target wellbore, wherein each of the plurality of simulated DCA-EUR sets comprises: (i) a simulated DCA generated based on respective simulation data, and (ii) a corresponding EUR for the simulated DCA;
generating, based on the input parameters, a target DCA for the target wellbore that forecasts the decline curve for the target wellbore; and
providing the target DCA as input to the machine learning model, wherein the machine learning model outputs the target EUR for the target wellbore, and wherein the target DCA and the target EUR form a target DCA-EUR set.

9. The system of claim 8, wherein the input parameters comprises a location of the target wellbore, a porosity of a reservoir in which the wellbore is drilled, a permeability of the reservoir, a frac conductivity of the reservoir, a number of hydraulic fracturing stages in a hydraulic fracturing operation in the reservoir, a fracture length, a fracture height, hydrocarbon saturation, cluster spacing between perforation clusters in the hydraulic fracturing operation, stage spacing, or reservoir pressure.

10. The system of claim 8, wherein generating the machine learning model comprises:
identifying a subset of the plurality of simulated DCA-EUR sets that corresponds to the input parameters; and
using the subset of the plurality of simulated DCA-EUR sets as training data for the machine learning model.

11. The system of claim 8, further comprising generating the synthetic database using a physics-based reservoir simulator.

12. The system of claim 11, wherein generating the synthetic database using the physics-based reservoir simulator comprises:
using an optimizer to select a plurality of simulation scenarios described by the respective simulation data;
for each simulation scenario, using the respective simulation data and the physics-based reservoir simulator to generate a corresponding simulated DCA-EUR set; and
storing the corresponding simulated DCA-EUR set in the synthetic database.

13. The system of claim 12, the operations further comprising:
for each simulation scenario, calculating an EUR accuracy for the corresponding simulated DCA-EUR set; and
storing the EUR accuracy in the synthetic database such that the EUR accuracy is associated with the corresponding simulated DCA-EUR set.

14. The system of claim 8, the operations further comprising calculating, using the machine learning model, an accuracy of the target EUR.

15. A non-transitory computer storage medium encoded with instructions that, when executed by one or more computers, cause the one or more computers to perform operations comprising:
obtaining input parameters describing a target wellbore for hydrocarbon production analysis;
generating, based on the input parameters and a synthetic database of a plurality of simulated decline curve analysis (DCA)—estimated ultimate recovery (EUR) sets, a machine learning model for generating a target EUR for the target wellbore, wherein each of the plurality of simulated DCA-EUR sets comprises: (i) a simulated DCA generated based on respective simulation data, and (ii) a corresponding EUR for the simulated DCA;
generating, based on the input parameters, a target DCA for the target wellbore that forecasts the decline curve for the target wellbore; and
providing the target DCA as input to the machine learning model, wherein the machine learning model outputs the target EUR for the target wellbore, wherein the target DCA and the target EUR form a target DCA-EUR set.

16. The non-transitory computer storage medium of claim 15, wherein the input parameters comprises a location of the target wellbore, a porosity of a reservoir in which the wellbore is drilled, a permeability of the reservoir, a frac conductivity of the reservoir, a number of hydraulic fracturing stages in a hydraulic fracturing operation in the reservoir, a fracture length, a fracture height, hydrocarbon saturation, cluster spacing between perforation clusters in the hydraulic fracturing operation, stage spacing, or reservoir pressure.

17. The non-transitory computer storage medium of claim 15, wherein generating the machine learning model comprises:
identifying a subset of the plurality of simulated DCA-EUR sets that corresponds to the input parameters; and
using the subset of the plurality of simulated DCA-EUR sets as training data for the machine learning model.

18. The non-transitory computer storage medium of claim 15, further comprising generating the synthetic database using a physics-based reservoir simulator.

19. The non-transitory computer storage medium of claim 18, wherein generating the synthetic database using the physics-based reservoir simulator comprises:
using an optimizer to select a plurality of simulation scenarios described by the respective simulation data;
for each simulation scenario, using the respective simulation data and the physics-based reservoir simulator to generate a corresponding simulated DCA-EUR set; and
storing the corresponding simulated DCA-EUR set in the synthetic database.

20. The non-transitory computer storage medium of claim 19, the operations further comprising:
for each simulation scenario, calculating an EUR accuracy for the corresponding simulated DCA-EUR set; and
storing the EUR accuracy in the synthetic database such that the EUR accuracy is associated with the corresponding simulated DCA-EUR set.
